(19) United States
(12) Patent Application Publication
(10) Pub. No.: US 2025/0184962 A1
(43) Pub. Date: Jun. 5, 2025

(54) PAGING FUNCTION IN A NON-TERRESTRIAL WIRELESS NETWORK (NTN)

(71) Applicant: Apple Inc., Cupertino, CA (US)

(72) Inventors: Chunhai Yao, Beijing (CN); Ankit Bhamri, Bad Nauheim (DE); Chunxuan Ye, San Diego, CA (US); Hong He, San Jose, CA (US); Haitong Sun, Cupertino, CA (US); Dawei Zhang, Saratoga, CA (US); Wei Zeng, Saratoga, CA (US)

(73) Assignee: Aoole Inc., Cupertino, CA (US)

(21) Appl. No.: 18/939,869

(22) Filed: Nov. 7, 2024

Related U.S. Application Data
(60) Provisional application No. 63/604,649, filed on Nov. 30, 2023.

(51) Int. Cl. H04W 68/02; H04J 13/00; H04W 72/23

(52) U.S. Cl. CPC H04W 68/02; H04J 13/0062; H04W 72/23

(57) ABSTRACT

Mechanisms are provided for a user equipment (UE) to receive a paging alert signal associated with a paging occasion. The UE can receive a synchronization signal from a wireless network, and further receive a paging alert signal (PAS). The PAS can indicate a paging occasion associated with the PAS. The UE can further receive information associated with the paging occasion associated with the PAS, information associated with the paging occasion being carried by a physical downlink control channel (PDCCH), and further receive a paging message carried by a Physical Downlink Shared Channel (PDSCH).

### RELATED APPLICATIONS

This application claims benefit of U.S. Provisional Patent Application No. 63/604,649 filed Nov. 30, 2023, the content of which is herein incorporated by references in its entirety.

### BACKGROUND

### Field

The described aspects generally relate to a non-terrestrial wireless network (NTN), including paging function for a user equipment (UE) in the NTN.

### Related Art

A wireless communication system can include a fifth generation (5G) system, a New Radio (NR) system, a long term evolution (LTE) system, a non-terrestrial wireless network (NTN), a combination thereof, or some other wireless systems. In addition, a wireless communication system can support a wide range of use cases such as enhanced mobile broad band (eMBB), massive machine type communications (mMTC), ultra-reliable and low-latency communications (URLLC), enhanced vehicle to anything communications (eV2X), among others. Enabling support for non-terrestrial networks has been one direction under exploration in the Third Generation Partnership Project (3GPP).

### SUMMARY

Some aspects of this disclosure relate to apparatuses and methods for implementing techniques for paging function between a user equipment (UE) and a non-terrestrial wireless network (NTN). Before a paging message is received by the UE, a paging alert signal (PAS) is received by the UE. In some embodiments, the PAS is transmitted with a higher priority than a physical downlink control channel (PDCCH), or occupies 127 sub-carrier in frequency domain. The implemented techniques can be applicable to many wireless systems, e.g., a wireless communication system based on 3rd Generation Partnership Project (3GPP) release 15 (Rel-15), release 16 (Rel-16), release 17 (Rel-17), or beyond.

Some aspects of this disclosure relate to a UE. The UE can include a transceiver configured to enable wireless communication in an NTN, and a processor communicatively coupled to the transceiver. The processor can receive a synchronization signal from the NTN, and further receive a paging alert signal (PAS), where the PAS is associated with the synchronization signal according to a frequency offset or a time offset with respect to the synchronization signal. In some embodiments, the synchronization signal can include a primary synchronization signal (PSS) and secondary synchronization signal, and the PAS can include a M-sequence or a Zadoff Chu sequence that can occupy one symbol. In some embodiments, the one symbol is a first symbol, and the PAS can be repeated multiple times occupying consecutive symbols adjacent to the first symbol. In some embodiments, the PAS can indicate a paging occasion associated with the PAS. In some embodiments, the PAS can be dropped when there is a collision with another signal. In some embodiments, the PAS is transmitted with a higher priority than the PDCCH, or occupies 127 sub-carrier in frequency domain.

Afterwards, the processor can receive information indicating the paging occasion associated with the PAS, information indicating the paging occasion being carried by the PDCCH. A time gap between the paging occasion and the PAS can be determined by a base station of the NTN. In response to the received information indicating paging occasion, the processor can further receive a paging message carried by a Physical Downlink Shared Channel (PDSCH).

According to some aspects, the paging occasion can be a first paging occasion, and the PAS can be associated with multiple paging occasions including the first paging occasion and a second paging occasion. The processor can receive information indicating the second paging occasion which may be carried by a second PDCCH, and receive a second paging message carried by a second PDSCH. In some embodiments, the paging occasion is a first paging occasion, the PAS is a first PAS, and the processor can further receive a second PAS associated with the synchronization signal from the NTN, where the second PAS is associated with a second paging occasion. Afterwards, the processor can receive information indicating the second paging occasion associated with the second PAS, the information indicating the second paging occasion being carried by a second PDCCH. Afterwards, the processor can receive a second paging message carried by a second PDSCH.

According to some aspects, the synchronization signal is a first synchronization signal, and the processor can further receive a second synchronization signal from the NTN, and receive the paging alert signal (PAS) associated with the second synchronization signal according to a second frequency offset or a second time offset determined by the NTN.

According to some aspects, the synchronization signal is a first synchronization signal, and the processor can receive a number of additional synchronization signals without an associated paging alert signal, where the number of synchronization signals is determined by a density parameter configured by a base station.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates a non-terrestrial wireless network (NTN) including a user equipment (UE) to receive a paging alert signal associated with a paging occasion, according to some aspects of the disclosure.

FIG. 2 illustrates a block diagram of a UE including a transceiver to receive a paging alert signal associated with a paging occasion in an NTN, according to some aspects of the disclosure.

FIG. 3 illustrates an example process performed by a UE for receiving a paging alert signal associated with a paging occasion in an NTN, according to some aspects of the disclosure.

FIGS. 4A-4D illustrate example processes performed by a UE for receiving a paging alert signal associated with a paging occasion in an NTN, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Non-terrestrial wireless networks (NTN) or non-terrestrial networks can refer to any network that involves non-terrestrial flying objects. An NTN can include a satellite communication network, a high altitude platform systems (HAPS), an air-to-ground network, a low-altitude unmanned aerial vehicles (UAVs, aka. drones), or any other NTN network. Due to the long distance a signal travels and the relative movements of a user equipment (UE) or a satellite in an NTN, a UE can suffer various performance issues in an NTN.

In a wireless network such as an NTN, when a UE does not have any ongoing data transmissions, the UE may enter an idle state in order to preserve battery. If new data arrives for the UE, the network can probe the UE by sending a paging message and the UE correspondingly responds. A paging occasion can be a specific subframe within a paging frame in which the network searches for an idle UE to deliver data to. Accordingly, the UE can wake up in a specific subframe, such as subframe 0, 4, 5 or 9 within a radio frame. These specific subframes within a paging frame when the UE wakes up are called as paging occasions (POs). A paging procedure based on the POs can be implemented to deliver the paging messages to the UE. Therefore, while in the idle state, the UE can keep monitoring for the paging message at certain device-specific times based on the POs. The UE can preserve the battery because, at other times, it may apply discontinuous reception (DRX) procedure to switch off its receiver.

In some wireless system such as a new radio (NR) system, paging functions or paging occasions can be triggered by Radio Resource Control (RRC) messages in addition to Downlink Control Information (DCI) carried by a Physical Downlink Control Channel (PDCCH). For example, in some embodiments, the paging function can be triggered by a paging early indication (PEI) or wake-up signal (WUS) carried by a PDCCH. In addition, paging messages can be carried by a Physical Downlink Shared Channel (PDSCH). However, such a paging mechanism used in the wireless system can lead to poor performance for the UE when the UE is placed in the pockets, backpacks, or other low signal-to-noise ratio (SNR) or non-line-of-sight (NLOS) conditions, such as when the UE is in a NTN system.

Some aspects of this disclosure provide mechanisms for a UE to transmit a paging alert signal (PAS) to the UE as system information that is being transmitted with a higher priority than the PDCCH. In some embodiments, the PAS occupies 127 sub-carrier in frequency domain. Accordingly, the PAS is different from the PEI or WUS carried by a PDCCH in other systems. The PAS can be transmitted in association with a synchronization signal/PBCH block (SSB) to indicate to the UE one or more upcoming paging occasions. Such a PAS transmitted by system information before the paging occasion can wake up the UE in case the UE is in a low power mode to get ready for receiving paging message. The PAS can be transmitted as a M-sequence or as a Zadoff-Chu sequence. There can be a frequency offset or time offset between the SSB and the paging alert signal. In addition, the PAS can be repeated by a predetermined number of times before the paging occasion associated with the PAS. The descriptions below are presented in terms of a NTN. However, techniques are not limited to a NTN, but may be applicable to any wireless systems.

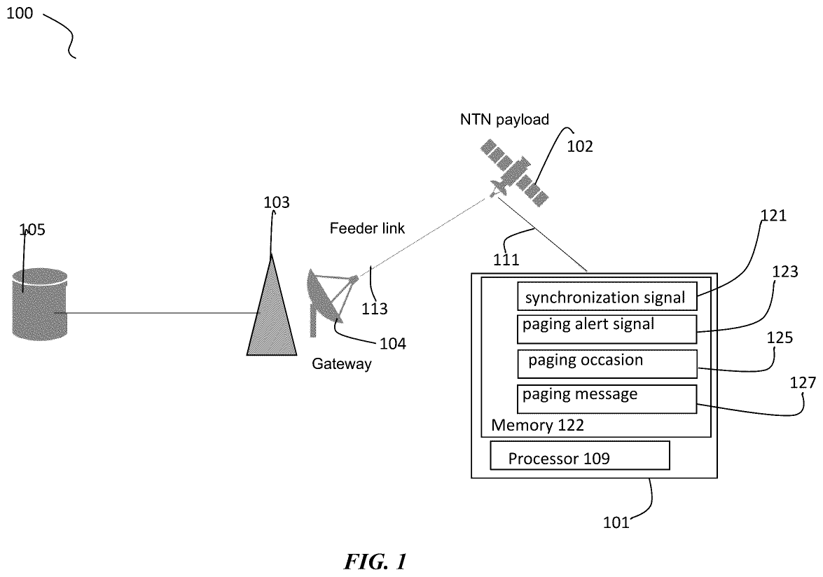

FIG. 1 illustrates a wireless system, e.g., NTN 100 including a UE 101 to receive a paging alert signal associated with a paging occasion, according to some aspects of the disclosure. NTN 100 is provided for the purpose of illustration only and does not limit the disclosed aspects.

NTN 100 can include, but is not limited to, UE 101, a base station 103, a satellite 102, a gateway 104, and a core network 105. UE 101 communicates with satellite 102 through a service link 111, and satellite 102 communicates with gateway 104 through a feeder link 113. Satellite 102 can include a network node or a transceiver for wireless communication. There can be various implementations of NTN 100. For example, base station 103 and gateway 104 may be integrated into one unit instead of being separated components. Base station 103 and core network 105 may implement functions as a normal terrestrial wireless network without a satellite, while gateway 104 may implementation functions between a terrestrial wireless network and satellite 102.

In some embodiments, NTN 100 can have a transparent payload, where base station 103 is located on the ground. In some embodiments, NTN 100 can have a regenerative payload when base station 103 can be located on satellite 102. There can be multiple satellites with onboard base stations communicating with each other. There can be other network entities, e.g., network controller, a relay station, not shown. An NTN can be referred to as a wireless network, a wireless communication system, or some other names known to a person having ordinary skill in the art.

In some embodiments, NTN 100 can be an NTN having a non-terrestrial flying object, e.g., satellite 102. In some embodiments, NTN 100 can include a satellite communication network that includes satellite 102, a HAPS, or an air-to-ground network, or a UAV. There can be multiple satellites in NTN 100. Satellite 102 can be a low Earth orbiting (LEO) satellite, a medium Earth orbiting (MEO) satellite, or a geosynchronous Earth orbiting (GEO) satellite. NTN 100 can be a HAPS, which can be an airborne platform including airplanes, balloons, and airships. For example, NTN 100 can include the International Mobile Telecommunications base stations, known as HIBS. A HIBS system can provides mobile service in the same transmission frequencies used by terrestrial mobile networks. NTN 100 can be an air-to-ground network to provide in-flight connectivity for airplanes by utilizing ground stations which play a similar role as base stations in terrestrial mobile networks. NTN 100 can also be a mobile enabled low-altitude UAVs.

In some embodiments, satellite 102 can be a GEO satellite deployed at an altitude of 35786 Km and is characterized by a slow motion around its orbital position with respect to a point on the Earth. Compared to terrestrial cellular systems, communication networks based on a GEO satellite have a large propagation delay that has to be taken into account in the overall design of the satellite network and high propagation losses. Additionally and alternatively, satellite 102 can be a LEO satellite at an altitude of 300-3000 km. As a consequence, satellite 102 can have a lower propagation delay, lower propagation losses and a higher Doppler frequency shift than a GEO satellite.

According to some aspects, base station 103 can be a fixed station or a mobile station. In some embodiments, base station 103 can be located onboard satellite 102. Base station 103 can also be called other names, such as a base transceiver system (BTS), an access point (AP), a transmission/reception point (TRP), an evolved NodeB (eNB), a next generation node B (gNB), a 5G node B (NB), or some other equivalent terminology.

According to some aspects, UE 101 can include a processor 109 and memory 122. UE 101 can be stationary or mobile. UE 101 can be a handheld terminal or a very small aperture terminal (VSAT) that is equipped with parabolic antennas and typically mounted on buildings or vehicles. UE 101 can be a cellular phone (e.g., a smart phone), a personal digital assistant (PDA), a wireless modem, a wireless communication device, a handheld device, a laptop, a desktop, a cordless phone, a wireless local loop station, a tablet, a camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

According to some aspects, UE 101 can be in an idle state, which means that it is not currently communicating with other devices, such as a base station, of NTN 100. Paging is used to alert UE 101 that there is data waiting for UE 101 on the network. When NTN 100 has data to send to UE 101, NTN 100 or its core network can initiate a paging procedure by sending a paging message to all cells that UE 101 is registered with. The message includes the identity of UE 101 and the location of the cell where UE 101 is expected to be located. UE 101 monitors the paging channel of the cell that the UE 101 is currently camped on and will respond to the paging message if UE 101 recognizes its identity in the paging message. If UE 101 does not respond within a certain time frame, the network will assume that UE 101 is not available and will retry the paging procedure in other cells where UE 101 is registered.

According to some aspects, a paging frame is a radio frame in which UE 101 monitors the paging channel (PCH) for paging messages. The paging frame can be specified in the System Information Block Type 2 (SIB2) and is typically set to a value that aligns with the radio frame boundary of the cell for UE 101. A paging occasion is a specific subframe within a paging frame in which the network searches for an idle UE to deliver data to. UE 101 can wake up in a specific subframe either subframe 0, 4, 5 or 9 within a radio frame. Therefore, these specific subframes within a paging frame when UE 101 wakes up are called as paging occasions. The paging occasion is used to minimize the signalling overhead by limiting the number of subframes that the network searches for idle UEs.

In some embodiments, a paging occasion is determined by the combination of the paging cycle and the radio frame number (RFN) of the cell. The paging cycle determines the interval between consecutive paging occasions. The RFN of the cell is a counter that increments with every radio frame. A paging frame specifies the radio frame within a paging cycle on which the network sends a paging message. In some embodiments, the paging frame can be set to any value from 0 to 1023, and different UEs can have different paging frames to avoid collisions. A paging group ID can be used to identify a group of UEs that share the same paging cycle, paging frame, and paging subframe. Paging group IDs are used to reduce the amount of paging overhead by minimizing the number of UEs that need to be paged. UE 101 may apply discontinuous reception (DRX) procedure to switch off its receiver. Paging DRX parameter can specify how often UE 101 should wake up to check for paging messages. The paging DRX parameter can be expressed in terms of a number of radio frames, with values ranging from 32 to 5120 frames. Longer DRX cycles can help to reduce power consumption but may also result in longer delays in receiving paging messages.

In some embodiments, processor 109 can be configured to establish a communication connection with base station 103 using a transceiver (not shown). Processor 109 can receive a synchronization signal 121 from NTN 100, and further receive a paging alert signal (PAS) 123. In some embodiments, PAS 123 can occupy 127 sub-carrier in frequency domain, or has a higher priority than the PDCCH. PAS 123 can be associated with synchronization signal 121 according to a frequency offset or a time offset with respect to the synchronization signal. PAS 123 can indicate a paging occasion 125 associated with PAS 123. In addition, processor 109 can receive information indicating paging occasion 125 associated with PAS 123, where the information indicating paging occasion 125 can be carried by the PDCCH. In response to received information indicating paging occasion 125, processor 109 can receive a paging message 127 carried by a Physical Downlink Shared Channel (PDSCH).

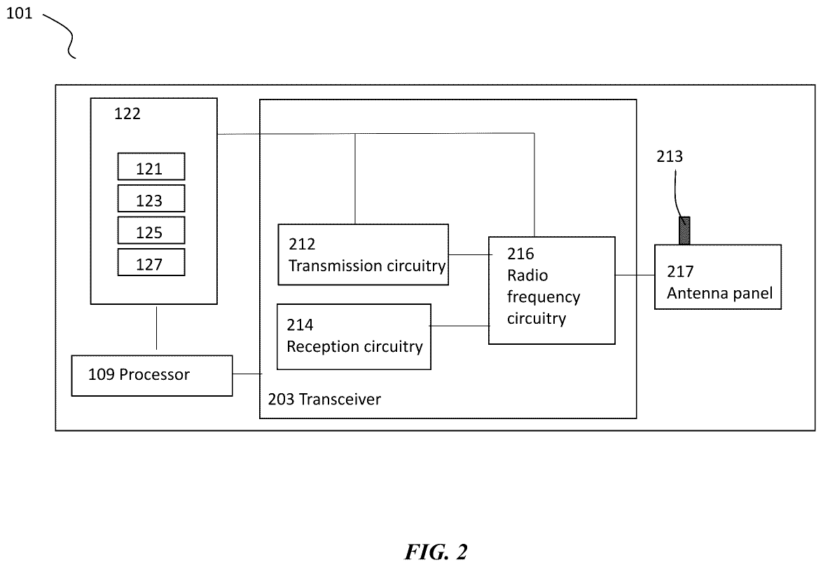

According to some aspects, UE 101 can be implemented according to a block diagram as illustrated in FIG. 2. Referring to FIG. 2, UE 101 can have antenna panel 217 including one or more antenna elements to form various transmission beams, e.g., transmission beam 213, coupled to a transceiver 203 and controlled by processor 109. Transceiver 203 and antenna panel 217 (using transmission beam 213) can be configured to enable wireless communication in a wireless network. In detail, transceiver 203 can include radio frequency (RF) circuitry 216, transmission circuitry 212, and reception circuitry 214. RF circuitry 216 can include multiple parallel RF chains for one or more of transmit or receive functions, each connected to one or more antenna elements of the antenna panel. In addition, processor 109 can be communicatively coupled to memory 122, which are further coupled to the transceiver 203. Various data can be stored in memory 122, such as data decoded from synchronization signal 121, PAS 123, paging occasion 125, and paging message 127.

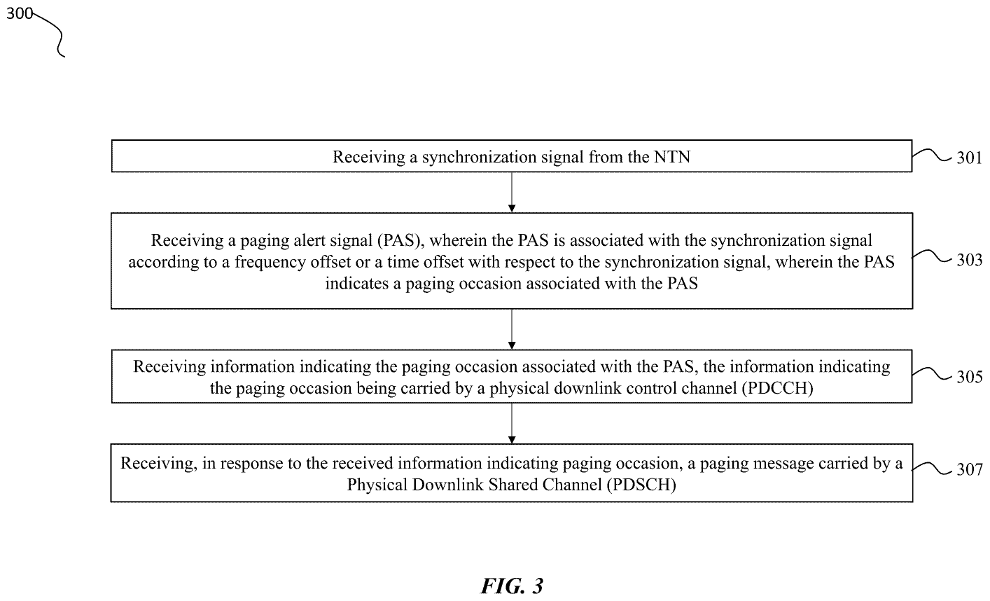

In some embodiments, memory 122 can include instructions, that when executed by the processor 109 perform operations described herein, e.g., operations to receive a paging alert signal associated with a paging occasion. Alternatively, the processor 109 can be “hard-coded” to perform the operations described herein. Operations performed by processor 109 or UE 101 may include operations as shown below in FIG. 3.

FIG. 3 illustrates an example process 300 performed by a UE for receiving a paging alert signal associated with a paging occasion in an NTN, according to some aspects of the disclosure. According to some aspects, as shown in FIG. 3, process 300 can be performed by UE 101, processor 109, or cause to be implemented by processor 109, or by system 500.

At 301, UE 101 can receive synchronization signal 121 from NTN 100. In some embodiments, synchronization signal 121 can be a PSS, or a secondary synchronization signal (SSS). Synchronization signal 121 can include synchronization signal blocks (SSBs). The purpose of a PSS is the initial symbol alignment and a coarse frequency correction. In some embodiments, a PSS can be a frequency-division multiplexing (FDM)-based binary phase shift keying (BPSK) M-sequence of 127 elements, thus occupying 127 subcarriers, which are known to one having the ordinary skills in the art.

At 303, UE 101 can receive PAS 123. In some embodiments, PAS 123 can be transmitted as system information instead of being carried by PDCCH, where system information can have a higher priority than PDCCH. PAS 123 can occupy 127 sub-carrier in frequency domain. In some embodiments, PAS 123 can include a M-sequence or a Zadoff Chu sequence, similar to a PSS. PAS 123 can be associated with synchronization signal 121 according to a frequency offset or a time offset with respect to synchronization signal 121. In some embodiments, base station 103 can configure the frequency offset between an SSB and PAS 123. In some other embodiments, base station 103 can configure the time offset between an SSB and PAS 123.

In some embodiments, PAS 123 can indicate a paging occasion associated with PAS 123. Base station 103 can configure a time period between transmission of PAS 123 and the associated PO. The value range of the time period can be in the level of a second, or minute. After the time period, UE 101 detects PAS 123, UE 101 can prepare to detect the paging information or paging message.

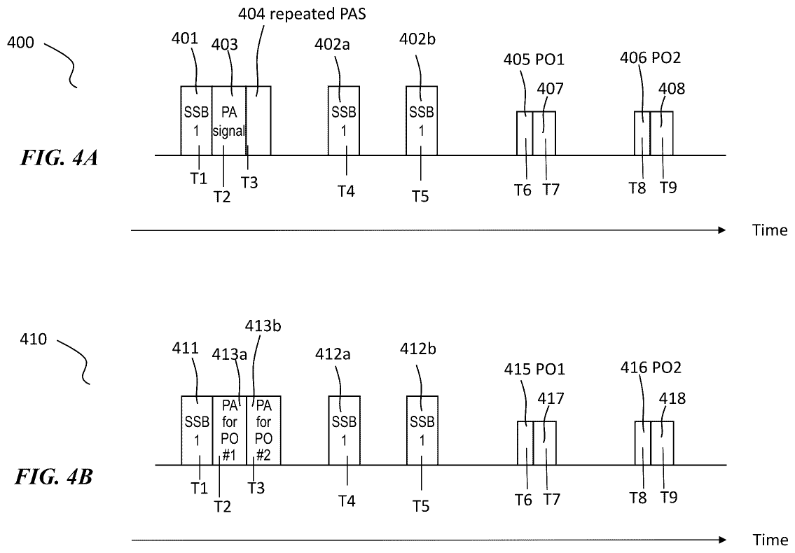

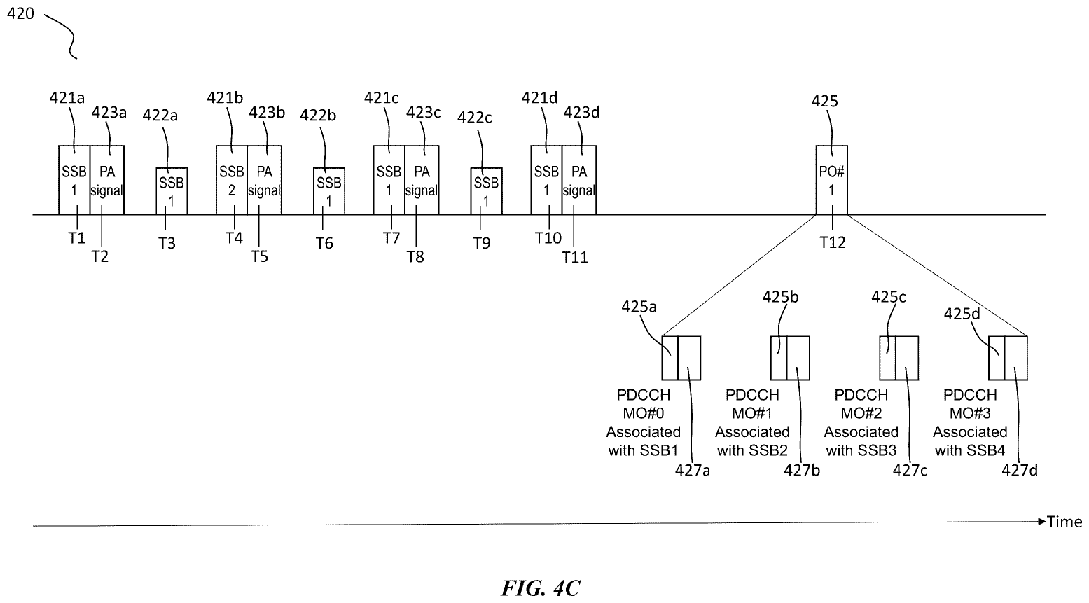

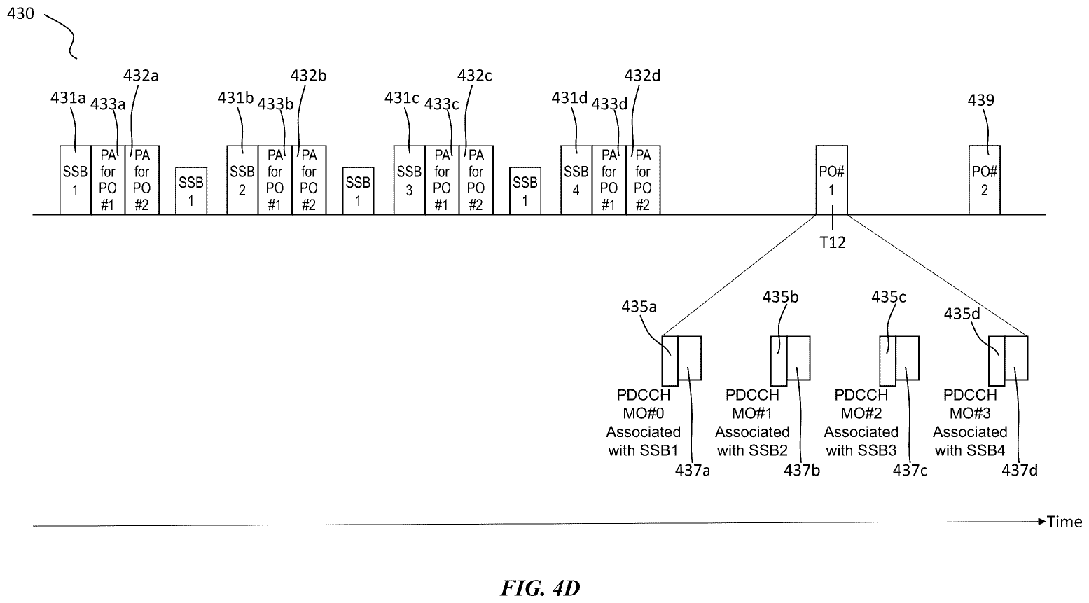

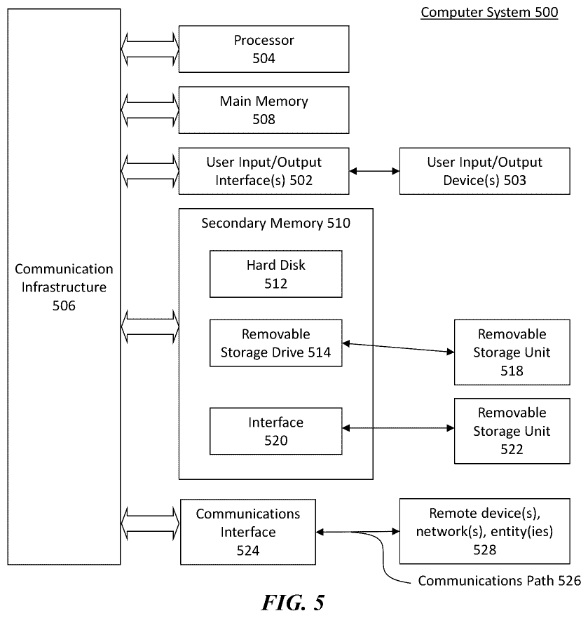

In some embodiments, PAS 123 can include an M-sequence or a Zadoff Chu sequence that can occupy one symbol. More details of PAS as an M-sequence or a Zadoff Chu are shown in the description for FIGS. 4A-4D.

At 305, UE 101 can receive information associated with paging occasion 125 that is associated with PAS 123, the information associated with paging occasion 125 can be carried by the PDCCH. In some embodiments, the information associated with paging occasion 125 can include control information related to a group of UEs to identify the group of UEs so that UE 101 can determine whether UE 101 is included in the group of UEs to receive the upcoming paging messages.

At 307, based on the received information associated with paging occasion 125, UE 101 can receive paging message 127 carried by a Physical Downlink Shared Channel (PDSCH).

FIGS. 4A-4D illustrate example processes, e.g., process 400, process 410, process 420, and process 430, performed by UE 101 (or processor 109, or caused to be performed by processor 109) for receiving a paging alert signal associated with a paging occasion in an NTN, according to some aspects of the disclosure. Process 400, process 410, process 420, and process 430 can be examples of process 300, illustrated with more, less, or different details.

Process 400 is shown in FIG. 4A, which can be an example of process 300 shown in FIG. 3. As illustrated, time flows from the left to the right, and various time instances, such as T1, T2, . . . T9, have an order in time, where T1<T2< . . . <T9.

Initially, at time instance T1, UE 101 can receive a SSB 401 carrying a synchronization signal from NTN 100. Afterwards, at time instance T2, UE 101 can receive a PAS 403 transmitted with a higher priority than a PDCCH. In some embodiments, PAS 403 can occupy one symbol. In some embodiments, the one symbol can be a first symbol, and PAS 403 can be repeated multiple times occupying consecutive symbols 404 adjacent to the first symbol and transmitted at time instance T3. In some embodiments, paging alert signal repetition can improve the detection performance for UE 101. Base station 103 can configure the number of repeated symbols for paging alert signal transmission as {1, 2, . . . , 8}. For example, a configuration of 4 may indicate PAS 403 can be transmitted repeatedly in four consecutive symbols to UE 101. In some embodiments, PAS 403 can indicate a paging occasion 405 associated with PAS 403. In some embodiments, PAS 403 can be dropped when there is a collision with another signal.

Afterwards, at time instance T6, UE 101 can receive information indicating paging occasion 405 associated with PAS 403, where the information indicating paging occasion 405 may be carried by the PDCCH. A time gap between paging occasion 405 and PAS 403 can be determined by base station 103 of NTN 100.

Afterwards, at time instance T7, in response to the received information associated with paging occasion 405, UE 101 can further receive a paging message 407 carried by a PDSCH.

According to some aspects, paging occasion 405 can be a first paging occasion, and PAS 403 can be associated with multiple paging occasions including paging occasion 405 and a second paging occasion 406. At time instance T8, UE 101 can further receive information indicating the second paging occasion 406, and further receive a second paging message 408 carried by a second PDSCH at time instance T9.

According to some aspects, the synchronization signal carried by SSB 401 can be a first synchronization signal, and UE 101 can receive a number of additional synchronization signals carried by SSB 402a received at time instance T4, and SSB 402b received at time instance T5, without an associated paging alert signal. As shown in FIG. 4A, SSB 402a is transmitted without an associated PAS being transmitted. The number of synchronization signals being transmitted without an associated PAS, such as SSB 402a, SSB 402b, is determined by a density parameter configured by base station 103. In some embodiments, to save the system overhead, paging alert signal density can be controlled by core network 105. In some embodiments, base station 103 can configure the paging alert signal density in a DRX/paging cycle, such that only the paging occasions in the last paging frame have the associated paging alert signal transmission. In some other embodiments, the paging alert signal density can be defined based on a paging alert signal cycle, where one paging alert cycle could include several paging cycles. In some embodiments, a paging alert signal cycle is relative to a SSB burst set, it can be configured with multiple of SSB periodicity, such as SSB-periodicity {5, 10, 20, 40, 80, 160} ms, while a paging alert signal cycle can be defined as K*SSB-periodicity, where K=1, 2, 3, . . . , or any integer. In some embodiments, a paging alert signal cycle can include multiple of paging cycle or extended paging cycle.

In some embodiments, PAS 403 can have a defined priority. If PAS 403 has a priority that is lower than a collided channel or signal, PAS 403 can be dropped without postponement. For example, when a SSB or a PDCCH has a higher priority than PAS 403, PAS 403 can be dropped in case of collision. In some embodiments, PAS 403 can always be dropped if there is a collision, or dropped due to DL to UL switching.

Process 410 is shown in FIG. 4B, where UE 101 can receive a paging alert signal associated with a paging occasion in an NTN. Process 410 can be an example of process 300 shown in FIG. 3. As illustrated, time flows from the left to the right, and various time instances, such as T1, T2, . . . T9 has an order in time, where T1<T2< . . . <T9.

Initially, at time instance T1, UE 101 can receive a SSB 411 carrying a synchronization signal from NTN 100. Afterwards, at time instance T2, UE 101 can receive a PAS 413a transmitted with a higher priority than a PDCCH. In some embodiments, PAS 413a can occupy one symbol. PAS 413a can indicate a paging occasion 415 associated with PAS 413a.

In some embodiments, paging occasion 415 is a first paging occasion, PAS 413a is a first PAS, and UE 101 can further receive a second PAS 413b associated with synchronization signal 411 at time instance T3, where the second PAS 413b indicates a second paging occasion 416.

Afterwards, at time instance T6, UE 101 can receive information associated with paging occasion 415 that associated with PAS 413a, where the information associated with paging occasion 415 can be carried by the PDCCH. Afterwards, in response to the received information associated with paging occasion 415, at time instance T7, UE 101 can further receive a paging message 417 carried by a PDSCH.

In addition, at time instance T8, UE 101 can receive information associated with second paging occasion 416 that is associated with the second PAS 413b, where the information associated with the second paging occasion 416 is carried by a second PDCCH. Afterwards, at time instance T9, UE 101 can receive a second paging message 418 carried by a second PDSCH.

In addition, UE 101 can receive a number of additional synchronization signals carried by SSB 412a received at time instance T4, SSB 412b received at time instance T5, without an associated paging alert signal.

Process 420 is shown in FIG. 4C, where UE 101 can receive a paging alert signal associated with a paging occasion in an NTN. Process 420 can be an example of process 300 shown in FIG. 3. As illustrated, time flows from the left to the right, and various time instances, such as T1, T2, . . . T12 has an order in time, where T1<T2< . . . <T12. For simplicity, some operations are described without stating the time instances.

Initially, at time instance T1, UE 101 can receive a SSB 421a carrying a synchronization signal from NTN 100. Afterwards, at time instance T2, UE 101 can receive a PAS 423a transmitted with a higher priority than a PDCCH. PAS 423a can indicate a paging occasion 425a associated with PAS 423a. At time instance T12, UE 101 can receive information associated with paging occasion 425a that is associated with PAS 423a, where the information associated with paging occasion 425a can be carried by the PDCCH. Afterwards, based on the received information associated paging occasion 425a, UE 101 can further receive a paging message 427a carried by a PDSCH.

According to some aspects, the synchronization signal included in SSB 421a is a first synchronization signal. At time instance T4, UE 101 can further receive SSB 421b including a second synchronization signal from the NTN, and receive, at time instance T5, a PAS 423b associated with the second synchronization signal in SSB 421b according to a second frequency offset or a second time offset determined by the NTN. PAS 423b indicates a paging occasion 425b associated with PAS 423b. At time instance T12, UE 101 can receive information associated with paging occasion 425b that is associated with PAS 423b, where the information associated with paging occasion 425b can be carried by the PDCCH. Afterwards, based on the received information associated with paging occasion 425b, UE 101 can further receive a paging message 427b carried by a PDSCH.

Additionally, at time instance T7, UE 101 can further receive SSB 421c including a third synchronization signal from the NTN, and receive, at time instance T8, a PAS 423c associated with the third synchronization signal in SSB 421c. PAS 423c indicates a paging occasion 425c associated with PAS 423c. At T12, UE 101 can receive information associated with paging occasion 425c that is associated with PAS 423c, where the information associated with paging occasion 425c can be carried by the PDCCH. Afterwards, based on the received information associated with paging occasion 425c, UE 101 can further receive a paging message 427c carried by a PDSCH.

Additionally, at time instance T10, UE 101 can further receive SSB 421d including a fourth synchronization signal from the NTN, and receive at time instance T11, a PAS 423d associated with the fourth synchronization signal in SSB 421d. PAS 423d indicates the paging occasion 425d associated with PAS 423d. At T12, UE 101 can receive information associated with paging occasion 425d that is associated with PAS 423d, where the information associated with paging occasion 425d can be carried by the PDCCH. Afterwards, in response to the received information associated with paging occasion 425d, UE 101 can further receive a paging message 427d carried by a PDSCH.

In addition, UE 101 can receive a number of additional synchronization signals carried by SSB 422a, SSB 422b, without an associated paging alert signal.

Process 430 is shown in FIG. 4D, where UE 101 can receive a paging alert signal associated with a paging occasion in an NTN. Process 420 can be an example of process 300 shown in FIG. 3. As illustrated, time flows from the left to the right. For simplicity, operations are described without stating the time instances.

Initially, UE 101 can receive a SSB 431a carrying a synchronization signal from NTN 100. Afterwards, UE 101 can receive a PAS 433a transmitted with a higher priority than a PDCCH. PAS 433a can indicate a paging occasion 435a associated with PAS 433a. UE 101 can receive information associated with paging occasion 435a that is associated with PAS 433a, where the information associated with the paging occasion 435a can be carried by the PDCCH. Afterwards, based on the received information associated with the paging occasion 435a, UE 101 can further receive, based on the information associated with the paging occasion 435a, a paging message 437a carried by a PDSCH. In addition, UE 101 can receive another PAS 432a that indicates a paging occasion 439 associated with PAS 432a. Details of page occasion 439 are not shown, but are similar to the paging occasion for PAS 433a.

According to some aspects, the synchronization signal included in SSB 431a is a first synchronization signal. UE 101 can further receive SSB 431b including a second synchronization signal from the NTN, and receive a PAS 433b associated with the second synchronization signal in SSB 431b. PAS 433b is to indicate the paging occasion 435b associated with PAS 433b. UE 101 can receive information associated with the paging occasion 435b that is associated with PAS 433b, where the information associated with the paging occasion 435b can be carried by the PDCCH. Afterwards, based on the received information associated with the paging occasion 435b, UE 101 can further receive a paging message 437b carried by a PDSCH. In addition, UE 101 can receive another PAS 432b that indicates a paging occasion 439 associated with PAS 432b, where the paging occasion 439 is different from the paging occasion associated with PAS 433a.

In addition, UE 101 can further receive SSB 431c including a synchronization signal from the NTN, and receive a PAS 433c associated with the synchronization signal in SSB 431c. PAS 433c indicates the paging occasion 435c associated with PAS 433c. UE 101 can receive information associated with paging occasion 435c that is associated with PAS 433c, where the information associated with paging occasion 435c can be carried by the PDCCH. Afterwards, based on the received information associated with paging occasion 435c, UE 101 can further receive a paging message 437c carried by a PDSCH. In addition, UE 101 can receive another PAS 432c that indicates a paging occasion 439 associated with PAS 432c.

In addition, UE 101 can further receive SSB 431d including a synchronization signal from the NTN, and receive a PAS 433d associated with the synchronization signal in SSB 43id. PAS 433d indicates a paging occasion 435d associated with PAS 433d. UE 101 can receive information associate with paging occasion 435d that is associated with PAS 433d, where the information associated with paging occasion 435d can be carried by the PDCCH. Afterwards, based on the received information associated with the paging occasion 435d, UE 101 can further receive a paging message 437d carried by a PDSCH. In addition, UE 101 can receive another PAS 432d that indicates a paging occasion 439 associated with PAS 432d.

In some embodiments, various PAS, such as PAS 433a, PAS 433b, PAS 433c, PAS 433d, PAS 432a, PAS 432b, PAS 432c, PAS 432d, PAS 423a, PAS 423b, PAS 423c, PAS 423d, PAS 413a, PAS 413b, and PAS 403 can be similar to PSS, occupying one symbol with 127 sub-carriers. Various PAS can be formed as an M-sequence. M-Sequence is a kind of Linear Feedback Shift Register (LFSR) sequence. LFSR is a shift register circuit in which two or more outputs from intermediate steps get linearly combined and feedback to input value.

In general, the M-Sequence d_{PAS}(n) for paging alert signal is defined by d_{PAS}(n)=1−2x(m), where m=(n+Z*N_{ID}^{(Ns)})mod 127 0≤n<127, and x(i+7)=(x(i+4)+x(i))mod 2 and [x(6)x(5)x(4)x(3)x(2)x(1)]=[1110110]. Parameter Z and N_{ID}^{(Ns)} are determined according to the number of paging occasion in a paging frame, N_{ID}^{(Ns)} is the page occasion index in a paging frame. Parameter Z can be configurable or predefined in the specification. Some examples of N_{ID}^{(Ns)} and parameter Z are provided below as examples for generating the M-Sequence, which can be used as PAS 433a, PAS 433b, PAS 433c, PAS 433d, PAS 432a, PAS 432b, PAS 432c, PAS 432d, PAS 423a, PAS 423b, PAS 423c, PAS 423d, PAS 413a, PAS 413b, and PAS 403.

In some embodiments, each paging occasion can have its own associated paging alert signal, as shown in FIG. 4D. Paging alert signals for different paging occasion can be transmitted in different symbol.

In some embodiments, if Ns=1, then N_{ID}^{(Ns)}=1; Z=0. If Ns=2, then N_{ID}^{(Ns)}={0,1}; Z=64 or Z=0. The first page occasion, i.e., N_{ID}^{(Ns)}=0, transmit in the first symbol for paging alert. The second paging occasion, i.e, N_{ID}^{(Ns)}=1, transmits in the second symbol for paging alert as shown FIG. 4D. If Ns=4, then N_{ID}^{(Ns)}={0,1,2,3}; Z=32, or Z=0. Four paging alert signals are transmitted in four symbols for four paging occasions.

In some embodiments, one paging alert signal can be shared by different paging occasions with different cyclic shifts, where a paging alert signal occupies one symbol. If Ns=1, then N_{ID}^{(Ns)}=1; Z=0. If UE detects the paging alert signal for the paging occasion, UE(s) in the group are paged.

In some embodiments, if Ns=2, then N_{ID}^{(Ns)}={0,1,2,3}; Z=32.
N_{ID}^{(Ns)}=0, the generated sequence means 01, UEs in page occasion #0 are paged
N_{ID}^{(Ns)}=1, the generated sequence means 10, UEs in page occasion #1 are paged
N_{ID}^{(Ns)}=2, the generated sequence means 11, both UEs in page occasion #0 and page occasion #1 are paged.
N_{ID}^{(Ns)}=3, the generated sequence means 00, neither UEs in page occasion #0 nor page occasion 1 # are paged.

If Ns=4, then N_{ID}^{(Ns)}={0, 1, . . . , 7}; Z=16. A total of eight sequences are generated, one sequence presents a state of four paging occasions combination, e.g., 0100.
If Ns=2, then N_{ID}^{(Ns)}={0,1,2}; Z=43
If Ns=4, then N_{ID}^{(Ns)}={0, 1, . . . , 6}; Z=19

For example, if there are four POs in a paging frame, i.e., Ns=4. If the UE belongs to the third paging alert group, e.g., N(s)=2. If UE detects the paging alert signal by correlating the paging alert sequence, then UE would know itself is paged, and prepare to receive the paging information.

In some embodiments, one sequence may be unnecessary for the case that all the UEs are not paged in any page occasions. Such as for Ns=2, “N_{ID}^{(Ns)}=3, the generated sequence means 00, neither UEs in page occasion #0 nor page occasion 1 # are paged.

In some embodiments, various PAS, such as PAS 423a, PAS 423b, PAS 423c, and PAS 423d can be a Zadoff Chu (ZC) sequence.

In some embodiments, a base sequence for the multiple PAS can be selected according to some known method, such as being defined in TS38.213 section 5.2.2. The length of the base sequence can be be equal to or larger than 12, e.g., 12, 18, 24, 30, or larger than 36. There can be 30 base sequences, r_{u,v}^{α,δ}(n)=e^{jα}r̅_{u,v}(n), u={0, 1, . . . , 29}. One paging alert signal can be shared by different paging occasions, paging alert signal occupies one symbol.

In some embodiments, a base sequence offset, k_{offset}, can be configured by the network on top of the below-selected base sequences. Base sequences used for Ns are predefined, or configurable. For example, if Ns=1, i.e., one paging occasion in a paging frame, then the first base sequence can be applied. If UE detects the first base sequence, UE would know it's paged. The base sequence offset can be in the range of {0, 1, . . . , 29}.

In some embodiments, if Ns=2, indicating two paging occasions in a paging frame. Four base sequences can be selected k_{offset}+1+n*7n=0,1,2,3. If k_{offset}=0, then the 1st, 8th, 15th, and 22nd base sequences are applied for paging alert indication. k_{offset} can be in the range of {0, 1, 2, 3, 4, 5, 6}. The 1st sequence means 00, both UEs in paging occasion #0 nor paging occasion 1 # are paged. The 8th sequence means 01, UEs in paging occasion #0 are paged. The 15th sequence means 10, UEs in paging occasion #1 are paged. The 22th sequence means 11, neither UEs in paging occasion #0 nor paging occasion #1 are paged.

In some embodiments, if Ns=4, i.e., four paging occasions are in a paging frame. Eighth base sequences are selected k_{offset}+1+n*3n=0, 1, . . . , 7. The 1st, 4th, 7th, 10th, 13th, 16th, 19th, 22nd base sequences are applied for paging alert indication. The base sequence offset can be in the range of (0, 1, 2).

In some embodiments, cyclic shift-based ZC sequence can be selected for paging alert signal. The length of the base sequence can be equal to or larger than 12, e.g., 12, 18, 24, 30, or larger than 36. The base sequences can be defined in TS38.213 section 5.2.2. The cyclic shift α is determined according to the base sequence length and number of paging occasions per paging frame.

In some embodiments, the initial cyclic shift offset m₀ can be configured by the network

$${r}_{u , v}^{α , δ} ( n ) = {e}^{j α} {\overline{r}}_{u , v} ( n ) , α = \frac{2 π}{{N}_{ZC}} ( ( {m}_{0} + {m}_{cs} ) mod {N}_{ZC} ) ,$$

where r_{u,v}^{α,δ}(n) is the ZF sequence after the cyclic shift α, r̅_{u,v}(n) is the base sequence, m₀ is the initial cyclic shift offset configured by network, m_{cs} is the cyclic shift, determined by Ns, the values of can be predefined me, or configurable by base station 103, and M_{ZC} is the ZC sequence length

In some embodiments, me, is predefined. If Ns=1, i.e., one paging occasion in a paging frame, then m_{cs}=0, there is no cyclic shift, or the cyclic shift is equal to m₀ if it's configured. If Ns=2, i.e., two paging occasions are in a paging frame. then m_{cs} =k*floor(N_{ZC}/4)k=0,1,2,3, four cyclic shifts are applied to generate four paging alert signal. The sequence with cyclic shift m_{cs} with k=0 means 00, UEs in paging occasion #0 are paged. The sequence with cyclic shift m_{cs} with k=1 means 01, UEs in paging occasion #1 are paged. The sequence with cyclic shift m_{cs} with k=2 means 10, both UEs in paging occasion #0 nor paging occasion 1 # are paged. The sequence with cyclic shift m_{cs} with k=3 means 11, neither UEs in paging occasion #0 nor paging occasion #1 are paged. If Ns=4, i.e., four paging occasions are in a paging frame. Accordingly, formula exists that m_{cs} =k*floor(N_{ZC}/8)k=0, 1, . . . , 7, the eight generated ZC sequences are generated for paging alert signal indication. If Ns=2, then me, =k*floor(N_{ZC}/3)k=0,1,2. If Ns=4, then m_{cs} =k*floor(N_{ZC}/7)k=0, 1, . . . , 6.

Various aspects can be implemented, for example, using one or more computer systems, such as computer system 500 shown in FIG. 5. Computer system 500 can be any computer capable of performing the functions described herein such as UE 101, or base station 103 as shown in FIG. 1 and FIG. 2, for operations described for processor 109 or process 300, process 400, process 410, process 420, or process 430 as shown in FIGS. 3, 4A-4D. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101, or base station 103 as shown in FIG. 1 and FIG. 2. In some examples, the operations include those operations illustrated and described for process 300, process 400, process 410, process 420, or process 430 as shown in FIGS. 3, 4A-4D.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method of performing wireless communication by a user equipment (UE) in a non-terrestrial wireless network (NTN), comprising:
receiving a synchronization signal from the NTN;
receiving a paging alert signal (PAS), wherein the PAS is associated with the synchronization signal according to a frequency offset or a time offset with respect to the synchronization signal, wherein the PAS indicates a paging occasion associated with the PAS;
receiving information associated with the paging occasion, the information associated with the paging occasion being carried by a physical downlink control channel (PDCCH); and
receiving, based on the information associated with the paging occasion, a paging message carried by a Physical Downlink Shared Channel (PDSCH).

2. The method of claim 1, wherein the PAS includes a M-sequence or a Zadoff Chu sequence.

3. The method of claim 1, wherein the paging occasion is a first paging occasion, and wherein the PAS is associated with multiple paging occasions including the first paging occasion and a second paging occasion, and the method further comprises:
receiving information associated with the second paging occasion carried by a second PDCCH; and
receiving a second paging message carried by a second PDSCH.

4. The method of claim 1, wherein the paging occasion is a first paging occasion, the PAS is a first PAS, and the method further comprises:
receiving a second PAS associated with the synchronization signal from the NTN, wherein the second PAS is associated with a second paging occasion; and
receiving information associated with the second paging occasion, the information associated with the second paging occasion being carried by a second PDCCH; and
receiving a second paging message carried by a second PDSCH.

5. The method of claim 1, wherein the PAS occupies one symbol.

6. The method of claim 5, wherein the one symbol is a first symbol, and the PAS is repeated multiple times occupying consecutive symbols adjacent to the first symbol.

7. The method of claim 1, wherein the synchronization signal is a first synchronization signal, and the method further comprises:
receiving a second synchronization signal from the NTN;
receiving the paging alert signal (PAS) associated with the second synchronization signal according to a second frequency offset or a second time offset determined by the NTN, wherein the PAS indicates the paging occasion associated with the PAS.

8. The method of claim 1, wherein the synchronization signal is a first synchronization signal, and the method further comprises:
receiving a number of additional synchronization signals without an associated paging alert signal, wherein the number of synchronization signals is determined by a density parameter configured by a base station.

9. The method of claim 1, wherein the synchronization signal is a synchronization signal and PBCH block (SSB) includes a primary synchronization signal (PSS) and a secondary synchronization signal.

10. The method of claim 1, wherein the paging alert signal is dropped when there is a collision with an other signal, or based on a priority rule defined between the paging alert signal and other signals.

11. The method of claim 1, wherein the PAS occupies 127 sub-carrier in frequency domain, or the PAS has a higher priority than the PDCCH.

12. A user equipment (UE), comprising:
a transceiver configured to enable wireless communication in a non-terrestrial wireless network (NTN); and
a processor communicatively coupled to the transceiver and configured to:
receive a synchronization signal from the NTN;
receive a paging alert signal (PAS), wherein the PAS is associated with the synchronization signal according to a frequency offset or a time offset with respect to the synchronization signal, wherein the PAS indicates a paging occasion associated with the PAS;
receive information associated with the paging occasion, the information associated with the paging occasion carried by a physical downlink control channel (PDCCH); and
receive, based on the information associated with the paging occasion, a paging message carried by a Physical Downlink Shared Channel (PDSCH).

13. The UE of claim 12, wherein the PAS includes a M-sequence or a Zadoff Chu sequence.

14. The UE of claim 12, wherein the paging occasion is a first paging occasion, and wherein the paging alert signal is associated with multiple paging occasions including the first paging occasion and a second paging occasion, and the processor is further configured to:
receive information associated with the second paging occasion carried by a second PDCCH; and
receive a second paging message carried by a second PDSCH.

15. The UE of claim 12, wherein the paging occasion is a first paging occasion, the paging alert signal is a first PAS, and the processor is further configured to:
receive a second PAS associated with the synchronization signal from the NTN, wherein the second PAS is associated with a second paging occasion; and
receive information associated with the second paging occasion that is associated with the second PAS, the information associated with the second paging occasion being carried by a second PDCCH; and
receive a second paging message carried by a second PDSCH.

16. The UE of claim 12, wherein the PAS occupies one symbol.

17. The UE of claim 16, wherein the one symbol is a first symbol, and the PAS is repeated multiple times occupying consecutive symbols adjacent to the first symbol.

18. The UE of claim 12, wherein the PAS occupies 127 sub-carrier in frequency domain, or the PAS has a higher priority than the PDCCH.

19. A non-transitory computer-readable medium storing instructions that, when executed by a processor of a user equipment (UE), cause the UE to perform operations, the operations comprising:
receiving a synchronization signal from the NTN;
receiving a paging alert signal (PAS), wherein the PAS is associated with the synchronization signal according to a frequency offset or a time offset with respect to the synchronization signal, wherein the PAS indicates a paging occasion associated with the PAS;
receiving information associated with the paging occasion associated with the PAS, the information associated with the paging occasion carried by a physical downlink control channel (PDCCH); and
receiving, in response to the received information associated with the paging occasion, a paging message carried by a Physical Downlink Shared Channel (PDSCH).

20. The non-transitory computer-readable medium of claim 19, wherein the paging occasion is a first paging occasion, and wherein the paging alert signal is associated with multiple paging occasions including the first paging occasion and a second paging occasion, and the operations further comprising:
receiving information associated with the second paging occasion carried by a second PDCCH; and
receiving a second paging message carried by a second PDSCH.
